(19) United States
(12) Patent Application Publication
(10) Pub. No.: US 2006/0248990 A1
(43) Pub. Date: Nov. 9, 2006

(54) Rescue tool for carrying a roof or sheet goods

(76) Inventors: Todd Bertholf, Blairstown, NJ (US); Eric K. Neuwirth, Columbia, NJ (US)

Correspondence Address: BENJAMIN APPELBAUM, PH.D.;ATTORNEY AT LAW, 27 BENNINGTON DRIVE, FLANDERS, NJ, 07836, US

(21) Appl. No.: 11/418,339

(22) Filed: May 4, 2006

Related U.S. Application Data
(60) Provisional application No. 60/677,890, filed on May 4, 2005.

(51) Int. Cl. B25B 7/12

(52) U.S. Cl. 81/367

(57) ABSTRACT

A device to support the roof of a vehicle comprises a pair of clamping arms joined together by a pivot pin, a helical spring and a quick release mechanism similar to the structure of a conventional locking plier, with an elongated clamping arm having a pair of ends, a fixed jaw attached to the first end, a moveable jaw attached to a first end of the second clamping arm, an adjustment screw attached to the elongated arm at the elongated arm second end, the adjustment screw being threadably inserted into the second end, the adjustment screw terminating in an adjustment knob, the arms each having a length, the length of the elongated arm being at least twice the length of the second arm, and the jaws being sized such that after adjustment, the jaws firmly grasp the roof of the vehicle.

### CROSS-REFERENCE TO RELATED APPLICATIONS

This application claims the benefit of U.S. Provisional Application for patent Ser. No. 60/677,890, filed 4 May 2005, the contents of which are hereby incorporated by reference herein in their entirety.

### FIELD OF THE INVENTION

This invention relates to a locking pliers having an extended, large diameter handle, and jaws for securing and allowing emergency personnel to grasp, support and carry a large item such as the roof of a motor vehicle. The device can also be used to support and carry sheet goods, such as plywood, wallboard or the like.

### BACKGROUND OF THE INVENTION

One of the many problems faced by emergency personnel when dealing with vehicular accidents is extricating a victim from a vehicle involved in the accident. Depending upon the accident, parts of the vehicle may be, for example only, inaccessible, damaged such that they are unusable, such as a smashed door, crushed because of the crumple-zone construction of many vehicles, and/or an accident victim trapped inside the vehicle who may be unable to extricate themself from the vehicle.

It is often necessary for emergency personnel to remove the roof from a vehicle in order to access the victim. Generally, the roof is separated from the vehicle body using a power saw, with rescue personnel grasping the roof by its sides, lifting it off the vehicle and hand carrying it to another location while other personnel attend to the victim's needs. The accident site poses other risks for rescue personnel as the footing may be uneven, vehicular fluids ranging from coolant, hydraulic fluids or fuel may have leaked onto the site, creating slippery or possibly flammable conditions, and the damage to the vehicle may create sharp edges. Removal of the roof also creates sharp edges which need to be grasped by rescue personnel such as firemen who are often wearing bulky protective clothing, boots and gloves. Thus, there is a need for a tool that rescue or emergency personnel can use at an accident scene to securely grip and then carry a roof from a vehicle. An embodiment of the present invention is described which is fully adjustable and can be used on most types of vehicular roofs. This embodiment utilizes a adjustable, locking jaw pliers with an extended, large diameter handle which can be adjusted to provide a firm grasp on the roof, and whose length provides leverage to aid in the easy removal of a roof once it has been separated from the body of the vehicle. This embodiment can also be used to handle other sheet metal components of a vehicle, such as, for example only, a hood, trunk or the like.

### BRIEF SUMMARY OF THE INVENTION

An object of the present invention is to provide a carrier that enables emergency personnel to stabilize and transport the roof of a motor vehicle.

Another object of the present invention is to provide a rescue tool with an elongated handle that enables leverage to be applied that facilitate the transport of a roof of a vehicle.

Another object of the present invention is to provide a rescue tool which when several such tools are simultaneously used by several persons, facilitates the carrying of a roof or similar article of sheet goods.

Still another object of the present invention is to provide a rescue tool that is durable, and can withstand the repeated and hard use involved in rescue functions.

### DESCRIPTION OF THE SEVERAL VIEWS OF THE DRAWING

FIG. 1 is a side view, partly in phantom, of a rescue tool in an open position.

FIG. 2 is a top plan view of the jaw, including a section of the handle member.

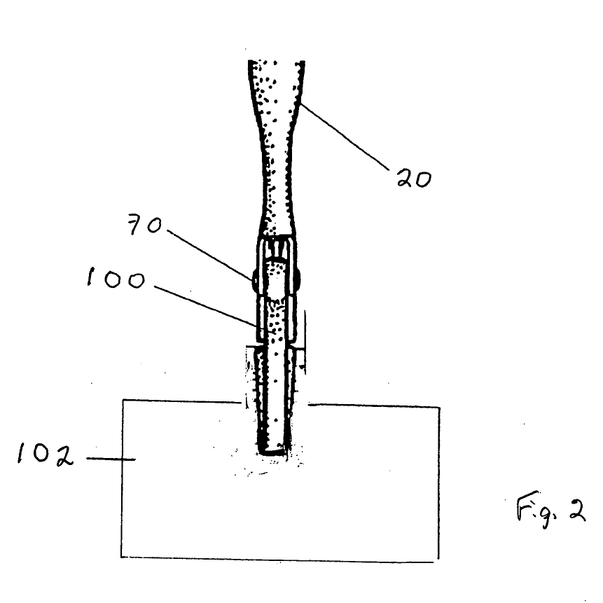

FIG. 3 is an embodiment of a stand to support the rescue tool.

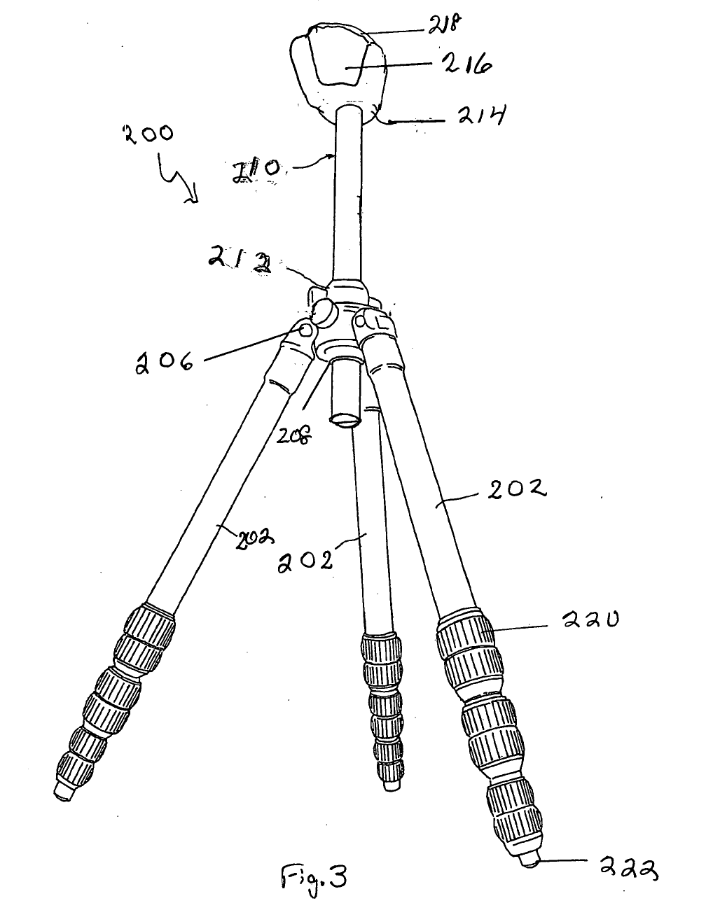

### DETAILED DESCRIPTION OF THE INVENTION

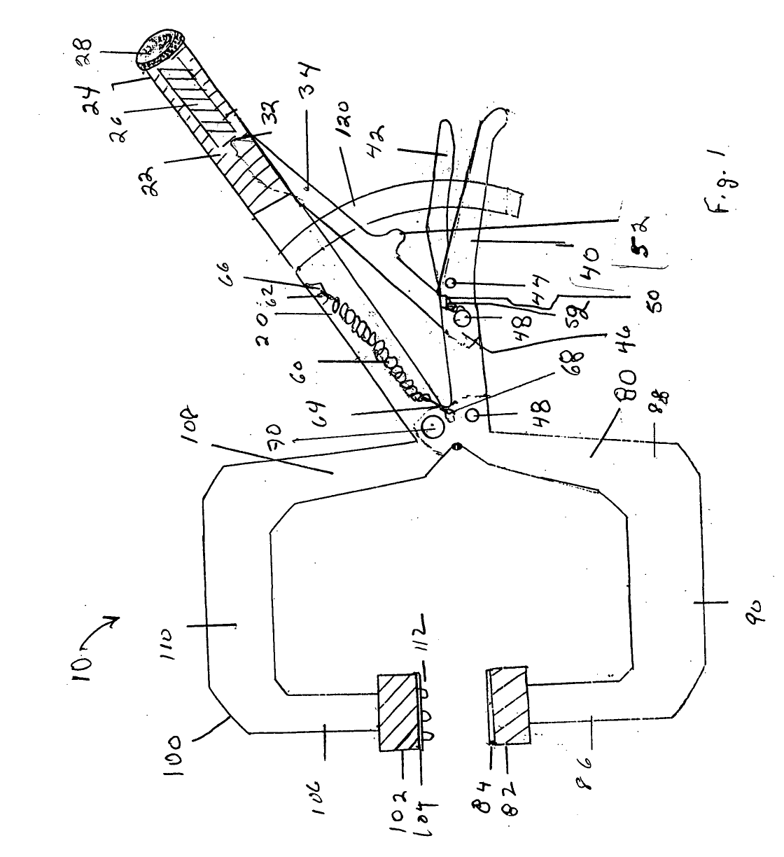

An embodiment of the present invention is a rescue tool 10 (FIG. 1) which comprises an elongated handle member 20, a lower handle member 40, and a pair of jaws, the lower jaw 80 being movable and the upper jaw 100 being fixed.

Elongated handle member 20 includes a knurled region 22 proximate an end 24 of the handle member 20. End 24 includes an opening through which an adjustment screw 26 is threadably inserted, and which adjustment screw 26 terminates in adjustment knob 28. The other end 30 of adjustment screw is in frictional engagement with a projection 32 at an end of toggle-like member 34.

The lower handle member 40 is generally channel-shaped, and includes a release lever 42 attached thereto by means of a pivot pin 44. When the rescue tool 10 is in the closed position, an end 50 of release lever 42 engages a second projection 52 of toggle-like member 34 (shown in phantom in FIG. 1). To open the rescue tool 10, release lever 42 is pivoted about pivot pin 44, urging projection 50 out of engagement with end 50, such that lower handle member 40 is moved away from handle member 20, and the jaws are opened. A second end 46 of toggle-like member 34 is retained within lower handle member by means of a pivot pin 48.

A spring 60 having two ends 62 and 64 is joined to the handle 20 at a prong 66 on the handle inside, the second end 64 joined to lower jaw member 40 through an opening 68 therethrough. A pivot pin 70 receives a portion of lower jaw member 40 therein, and pivotably retains the lower jaw member within handle 20.

The jaws 80 and 100 are both generally C-shaped, a difference being that lower jaw 80 is movable while upper jaw 100 is fixed. Each jaw terminates in a pad 82 and 102, respectively. In the embodiment illustrated, the pads 80 and 102 are rectangular in shape, and are provided with a rubber surface 84 and 104, respectively. The rubber surfaces 84 and 104 both facilitate the grip of rescue tool 10 on a workpiece, and also may provide a surface that may not mar the surface of the workpiece (depending upon the ultimate use of the rescue tool).

The surface of pads 82 and 102 may also include a plurality of nibs 112 to increase the grip of the pads onto the workpiece. In one embodiment, pads 82 and 102 have dimensions of about 6 inches by about 3 inches, but other sizes and configurations could be substituted therefor without deviating from the scope of the invention. Although not shown in the drawing, such alternate embodiments can include pads which are pivotably mounted to jaws 80 and 100, thereby enabling the rescue tool to conform to the shape of the workpiece, such as a curved surface of a vehicle roof.

In the embodiment illustrated, the distance between the front arms 86 and 106, and the back arms 88 and 108 of the lower and upper jaws 80 and 100, respectively, is between 10 to about 20 inches, with a distance of between 6 and 18 inches between the central arms 90 and 110, respectively. The jaws can expand up to a distance of about 6 inches, although greater expansion distances are possible with additional modification of component sizes.

Several components of the rescue tool 10 are similar to that of a locking pliers sold under the trademark of VISE-GRIP® (Irwin Industrial Tool Co., Freeport, Ill.), and described in U.S. Pat. No. 2,280,005, the contents of which are hereby incorporated by reference, particularly as it relates to the over center locking mechanism, and the adjustment mechanism.

The rescue tool's handle 20 is an elongated handle, having a length that is about twice the length of the lower handle member 40. The length of the handle 20 is generally between 1 and 3 feet. The handle 20 has a diameter that is substantially greater than that of most of the locking grip pliers commonly on the market, and this is between 1 and 3 inches.

The knurled region 22 extends for approximately one-third the length of the handle member 20. This extended knurled region 22 enables the user to obtain a secure grip on the rescue tool during its use, because frequently the emergency personnel who are using the rescue tool are wearing bulky gloves.

A security strap 120 is attached to handle 20, with a length that is sufficient to be wrapped around the lower handle 40 and secure the handles in the closed position such that they will not open in the event of an jarring of release lever 42 while the rescue tool 10 is in use. Such a security strap may be a rope, made of a material that is commonly used for rope; a strap of leather which can be tied, buckled, adjusted or the like; an elastomeric material; a strip of a hook and loop material, such as that sold under the trademark of VELCRO® (registered trademark of Velcro Industries, Curacao, Netherlands Antilles); or other material known to those skilled in the art.

When used in the removal of a roof from a vehicle, such as that of an automobile, it is most convenient to use four rescue tools, with one tool being attached at or near each corner of the roof. In this manner, four people can stabilize the roof and prevent it from falling into the vehicle while other personnel cut the roof from the vehicle body; these same people can then transport the cut roof away from the vehicle. Alternatively, should fewer people be available, two rescue tools, with one tool being attached to each side of the roof, could be used by two people. To attach the rescue tool, the jaws are opened to an appropriate distance, then positioned on a desired section, after which adjustment screw is adjusted so the jaws securely grasp the roof. Because of the extended length of the handle 20, rescue personnel can grasp the rescue tool, and position themselves a distance from the vehicle while the roof is being cut. The extended length also provides leverage so that once the roof has been cut, it can be easily transported away from the vehicle. If the roof of the vehicle is particularly large, it may be necessary to use additional rescue tools to stabilize and transport the cut roof; the actual number needed will generally be dictated by the particular circumstances. When more than one rescue tool is being used on a vehicle, the rescue tools should be attached so that the roof is supported evenly, and this can entail using rescue tools on opposite sides of the roof, or diagonally opposed to one another, depending upon the particular circumstances. If only a limited number of emergency personnel are on site, it is still possible to employ multiple rescue tools, but support the additional tools by means of an adjustable support stand which supports the handle while the jaws are in contact with the vehicle. Even if the roof has been damaged, it is still possible to find regions on the roof where the rescue tool can be attached, and used to stabilize the roof for removal.

A representative stand 200 is a tripod-like structure, or can be similar to an oversized jack stand. Stand 200 comprises a plate 202 to which legs 204 are pivotably attached by pins 206. The plate 202 includes a central opening 208 through which a column 210 is passed. In the embodiment illustrated herein, the column is manually adjusted up or down by loosening or tightening of a locking ring 212. The column 210 is terminates in a head 214 that has the shape of an inverted semi-circle, with an opening 222 into which opening 222 the handle 20 of the rescue tool is positioned. A security strap 224, such as a spring, may be attached to the head 220 and can be wrapped around the handle 20 to hold it in position.

Legs 208 are attached to the plate, the legs being adjustable by means of a conventional telescoping mechanism commonly used for tripods. The legs may be locked in place using either a twist-turn locking mechanism 220 shown in the figure, or using a lever-type locking mechanism. The angle and the length of each leg can be adjusted individually, such that the stand can be positioned even when used on uneven ground. Although not shown in the drawings, the foot 222 of each leg can include a telescoping stud or prong, which can be exposed and enable the leg to be positioned in moist or rough ground. For additional support, the legs may be braced to the column using braces (also not shown).

Although the previous description has focused on the use of the rescue tool 10 for the removal and carrying of a vehicle's roof, it is to be understood and contemplated that the use of this embodiment is not to be limited solely to carrying a roof, but can be extended to carry other items of sheet metal, such as the hood or trunk of a vehicle, fenders or quarter panels, other vehicular components, aircraft components, railroad car or railroad engine components or sheet goods manufactured of other materials, such as wood, aluminum, fiberglass, plywood, oriented strand board, wood laminates, composites, gypsum board, wall board, cement board, and the like.

Therefore, although this invention has been described with a certain degree of particularity, it is to be understood that the present disclosure has been made only by way of illustration and that numerous changes in the details of construction and arrangement of parts may be resorted to without departing from the spirit and scope of the invention.

We claim:

1. A device for supporting the roof of a vehicle, the device having a pair of clamping arms joined together by a pivot pin, a helical spring and a quick release mechanism similar to the structure of a conventional locking plier, the device comprising:
an elongated clamping arm having a pair of ends, a fixed jaw attached to the first end;
a moveable jaw attached to a first end of the second clamping arm;
an adjustment screw attached to the elongated arm at the elongated arm second end, the adjustment screw being threadably inserted into the second end, the adjustment screw terminating in an adjustment knob;
the arms each having a length, the length of the elongated arm being at least twice the length of the second arm; and
the jaws being sized such that after adjustment, the jaws firmly grasp the roof of the vehicle.

2. The device as described in claim 1, further comprising a security strap.

3. The device as described in claim 2, wherein the security strap comprises a body having a length and a pair of ends, the first end being attached to the elongated arm, the length of the strap being sufficiently long to enable the strap to be wrapped around the second arm and maintain the arms in a closed position during use of the device.

4. The device as described in claim 3, wherein the security strap is chosen from the group consisting of rope, leather, an elastomeric material, and a hook and loop material.

5. The device as described in claim 4, wherein the strap second end comprises a means for securing the strap second end to the strap body.

6. The device as described in claim 2, wherein the jaws terminate in a pad.

7. The device as described in claim 6, wherein the pad further comprises a plurality of nibs.

8. The device as described in claim 2, wherein the elongated arm has a length from about one foot to about three feet.

9. The device as described in claim 8, wherein the elongated arm has a diameter from about one inch to about three inches.

10. The device as described in claim 6, wherein the pads are pivotably attached to the jaws.

11. The device as described in claim 8, wherein the knurled portion of the elongated arm extends for about one-third the length of the elongated arm.

12. A method for supporting the roof of a vehicle, the method comprising the steps of:
attaching to the roof a device for supporting the roof, the device having a pair of clamping arms joined together by a pivot pin, a helical spring and a quick release mechanism similar to the structure of a conventional locking plier, the device comprising:
an elongated clamping arm having a pair of ends, a fixed jaw attached to the first end;
a moveable jaw attached to a first end of the second clamping arm;
the jaws terminating in a rubber pad;
an adjustment screw attached to the elongated arm at the elongated arm second end, the adjustment screw being threadably inserted into the second end, the adjustment screw terminating in an adjustment knob;
the arms each having a length, the length of the elongated arm being at least twice the length of the second arm;
a security strap comprising a body having a length and a pair of ends, the first end being attached to the elongated arm, the length of the strap being sufficiently long to enable the strap to be wrapped around the second arm and maintain the arms in a closed position during use of the device; and
the jaws being sized such that after adjustment, the jaws firmly grasp the vehicle roof; and
providing a means for supporting the attached device, thereby supporting the roof.

13. The method as described in claim 11, wherein the attaching step further comprises the step of attaching one or more additional devices to the vehicle roof.

14. The method as described in claim 13, wherein the means for supporting the device is a stand comprising a means for receiving the elongated arm.

15. The method as described in claim 13, wherein the attaching step further comprises the step of attaching the devices to opposite sides of the roof.

16. The method as described in claim 15, further comprising the steps of removing the roof using a means for removing a roof.

17. The method as described in claim 16, further comprising the step of carrying the removed roof from the vehicle using the attached device.

18. A device for supporting the roof of a vehicle, the device having a pair of clamping arms joined together by a pivot pin, a helical spring and a quick release mechanism similar to the structure of a conventional locking plier, the device comprising:
an elongated clamping arm having a pair of ends, a fixed jaw attached to the first end;
a moveable jaw attached to a first end of the second clamping arm;
the jaws terminating in a rubber pad;
an adjustment screw attached to the elongated arm at the elongated arm second end, the adjustment screw being threadably inserted into the second end, the adjustment screw terminating in an adjustment knob;
the arms each having a length, the length of the elongated arm being at least twice the length of the second arm;
a security strap comprising a body having a length and a pair of ends, the first end being attached to the elongated arm, the length of the strap being sufficiently long to enable the strap to be wrapped around the second arm and maintain the arms in a closed position during use of the device; and
the jaws being sized such that after adjustment, the jaws firmly grasp the vehicle roof.

19. The device as described in claim 18, wherein the security strap is chosen from the group consisting of rope, leather, an elastomeric material, and a hook and loop material.

20. The device as described in claim 19, wherein the elongated arm has a length from about one foot to about three feet.

21. The device as described in claim 20, wherein the elongated arm has a diameter from about one inch to about three inches.

22. The device as described in claim 21, wherein the pads are pivotably attached to the jaws.
